(19) United States
(12) Patent Application Publication
(10) Pub. No.: US 2022/0245697 A1
(43) Pub. Date: Aug. 4, 2022

(54) METHODS AND APPARATUS FOR IMPROVING SEARCH RETRIEVAL

(71) Applicant: Walmart Apollo, LLC, Bentonville, AR (US)

(72) Inventors: Lin Gong, Sunnyvale, CA (US); Mossaab Bagdouri, Tetouan (MA); Min Xie, Santa Clara, CA (US)

(21) Appl. No.: 17/163,373

(22) Filed: Jan. 30, 2021

(51) Int. Cl. G06Q 30/06; G06F 16/9035; G06F 16/903; G06F 40/247

(52) U.S. Cl. CPC G06Q 30/0625; G06Q 30/0643; G06F 40/247; G06F 16/90344; G06F 16/9035

(57) ABSTRACT

The disclosed subject matter relates to a system and method for providing an extended search. The system generates a list of synonym groups based on previous engagements linking queries and products. With receipt of a user query, the system accesses synonyms to the search terms and incorporates them into the query of the product catalog in order to obtain a complete set of results. The creation of the synonym groups uses various approaches including sequence tagging and graph embedding to identify synonyms in the query and the item titles.

### TECHNICAL FIELD

The disclosed subject matter relates generally to automated assistants providing information from a database to a user in response to a user communication. Specifically, an automated shopping assistant providing relevant products by extending the search query to synonyms.

### BACKGROUND

In recent years, with the development of cognitive intelligence technology, the success rate of speech recognition has been greatly improved, and applications based on speech recognition as well as natural language processing have also been comprehensively promoted. In addition to basic applications such as voice input, voice-based and text-based human-computer interaction applications such as voice and online assistants (i.e. automated assistants) have gradually become the standard configuration of intelligent systems. Such assistants can allow users to interact with devices or systems using natural language in spoken and/or text forms. For example, a user can provide a speech input containing a user request to an automated assistant operating on an electronic device. The digital assistant can interpret the user's intent from the speech input and operationalize the user's intent into tasks. The tasks can then be performed by executing one or more services of the electronic device, and a relevant output responsive to the user request can be returned to the user.

In the prior art, the voice assistant is usually used in conjunction with the knowledge base. The front end first recognizes the user's voice input, converts the voice information into text information, and then queries the knowledge base, and matches the query with the voice content.

Intelligent automated assistants can provide an intuitive interface between users and electronic devices. Furthermore a digital assistant can be utilized to assist with searching for consumer products and/or there attributes. Synonyms play an important role in E-Commerce as it can enable many useful applications such as query rewriting and query expansion, in order to bridge the gap between user input query and catalog items.

While natural language processing may result in an intent (i.e. product type), synonyms for the product type may not be searched. Automotive batteries and vehicle batteries, pencil cases and pencil boxes are examples of product type synonyms. If the natural language processing is unable to predict all the synonyms of the query, the resultant search may fail to extract all of the relevant items matching all the product types from the catalog (database).

In prior art systems, a user query for “jeep liberty battery” may lead to a detected product type of “Automotive Batteries” and the resultant search using the detected product type for example may return:
Battery for Harley classic liberty 1986- $69.99;
Revolution Mobility Liberty 312 Power Wheel Chair Battery-$63.99;
Major Mobisist Liberty Wheelchair Battery- $89.19; and,
Replacement for Jeep Liberty Battery 2011- $376.89.

A search using the synonym “Vehicle Batteries” along with the product type of “Automotive Batteries” or “Car Batteries” as described in the disclosed subject matter advantageously returns:
Replacement for Jeep Liberty Battery 2011-$376.89;
Replacement for Jeep Liberty Battery 2007-$352.68;
Replacement for Jeep Liberty Battery 2009-$352.68; and,
Replacement for Jeep Liberty Battery 2011-$352.68.

Thus searching only the “Automotive Batteries” product type misses relevant items (the last three products), but by adding the synonym of “Vehicle Batteries” or “Car Batteries” as described in the disclosed subject matter herein, the most relevant products including those missed are advantageously captured. Other illustrative examples of synonyms groups include “dinnerware”, “dishware” and “dinner plates” for dishes, and “icing color” and “food coloring” for food dye. Retrieving the most relevant returns is recognized as an important search metric which is particularly beneficial in an online retail environment. Thus it is important to discover and utilize synonyms to achieve this benefit.

### SUMMARY

The embodiments described herein are directed to a system and method for retrieving information from a knowledge base in response to a user's natural language question, specifically with an automated shopping assistant. In addition to or instead of the advantages presented herein, persons of ordinary skill in the art would recognize and appreciate other advantages as well.

In accordance with various embodiments, exemplary systems may be implemented in any suitable hardware or hardware and software, such as in any suitable computing device.

In some embodiments, a system extending the retrieval of relevant information is provided. The system including a communication system; a database; and, a computing device connected to both the database and the communication system. The computing device configured to receive an user input query, including the first product type; retrieve a synonym of the first product type from a synonym group stored in the database; and create an extended query from the first product type and the retrieved synonym. The computing device is also configured to query the database with the extended query; receive the extended query results from the database; and, transmit the extended query results to the user in response to the input query.

In some embodiments, a method for improving search retrieval is provided. The method includes determining a synonym for a first product type; receiving an input query from a user, the input query including the first product type; and retrieving the synonym of the first product type. The method further includes creating an extended query from the first product type and the synonym; querying a database with the extended query; and transmitting the extended query results received from the database to the user in response to the input query.

In yet other embodiments, a non-transitory computer readable medium having instructions stored thereon is provided. The instructions, when executed by at least one processor, cause a device to perform operations including in a first module instructions for the operations of determining synonyms for a plurality of product types and storing the determined synonyms in synonym groups. In a second module the instructions cause the operations of receiving an input query from a user, including a first product type; retrieving a respective synonym of the first product type from the synonym group; and creating an extended query from the first product type and the respective synonym. The operations further include querying a database with the extended query; receiving the extended query results from the database; and, transmitting the extended query results to the user in response to the input query.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of communication network used to retrieve relevant information contained in the knowledge base in accordance with some embodiments;

FIG. 2 is a block diagram of the computing device of the communication system of FIG. 1 in accordance with some embodiments;

FIG. 3 is a flow diagram of an extended search according to some embodiments;

FIG. 4 is a flow diagram for mining synonyms in accordance with embodiments of the disclosed subject matter;

FIG. 5 is a flowchart of a method for extending searches in accordance with embodiments of the disclosed subject matter.

FIG. 6 is a flowchart of a method for mining synonyms in accordance with embodiments of the disclosed subject matter.

FIG. 7 is a flowchart of another method for mining synonyms in accordance with embodiments of the disclosed subject matter.

The description of the embodiments is intended to be read in connection with the accompanying drawings, which are to be considered part of the entire written description of this disclosure. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

### DETAILED DESCRIPTION

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

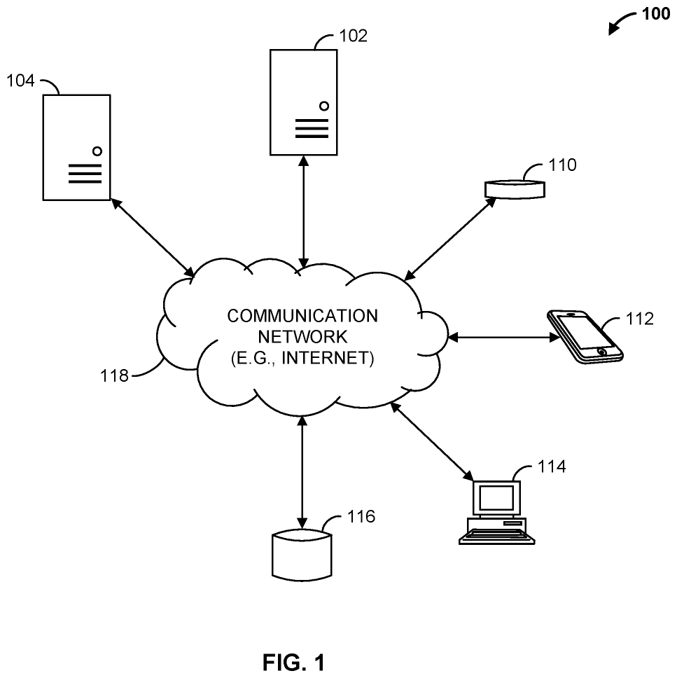

Turning to the drawings, FIG. 1 illustrates a block diagram of a communication system 100 that includes an extended search computing device 102 (e.g., a server, such as an application server), a web server 104, database 116, and multiple customer computing devices 110, 112, 114 operatively coupled over network 118.

An extended search computing device 102, server 104, and multiple customer computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, or through the communication network 118.

In some examples, the extended search computing device 102 may be a computer, a workstation, a laptop, a server such as a cloud-based server, or any other suitable device. In some examples, each of multiple customer computing devices 110, 112, 114 can be a cellular phone, a smart phone, a tablet, a personal assistant device, a voice assistant device, a digital assistant, a laptop, a computer, or any other suitable device. In some examples, extended search computing device 102, and web server 104 are operated by a retailer, and multiple customer computing devices 112, 114 are operated by customers of the retailer.

Although FIG. 1 illustrates three customer computing devices 110, 112, 114, communication system 100 can include any number of customer computing devices 110, 112, 114. Similarly, the communication system 100 can include any number of workstation(s) (not shown), extended search computing devices 102, web servers 104, and databases 116 and 117.

The extended search computing device 102 is operable to communicate with database 116 over communication network 118. For example, the extended search computing device 102 can store data to, and read data from, database 116. Database(s) 116 may be remote storage devices, such as a cloud-based server, a disk (e.g., a hard disk), a memory device on another application server, a networked computer, or any other suitable remote storage. Although shown remote to the extended search computing device 102, in some examples, database 116 may be a local storage device, such as a hard drive, a non-volatile memory, or a USB stick. The extended search computing device 102 may store data from workstations or the web server 104 in database 116. In some examples, storage devices store instructions that, when executed by the extended search computing device 102, allow the extended search computing device 102 to determine one or more results in response to a user query.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

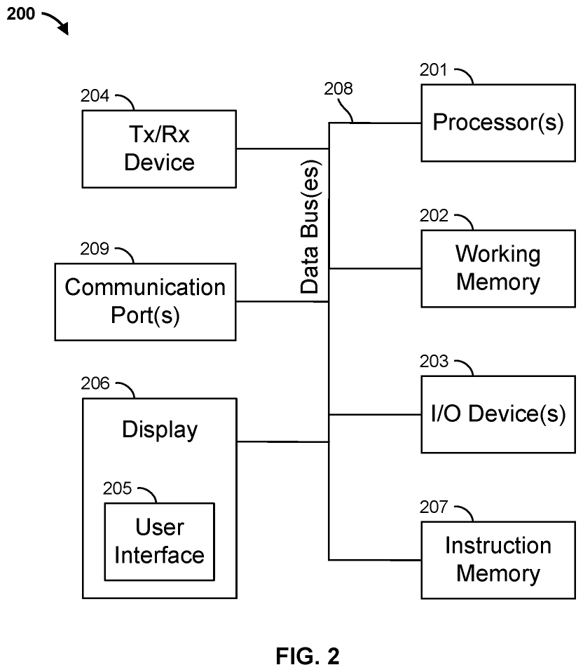

FIG. 2 illustrates the extended search computing device 102 of FIG. 1. The extended search computing device 102 may include one or more processors 201, working memory 202, one or more input/output devices 203, instruction memory 207, a transceiver 204, one or more communication ports 207, and a display 206, all operatively coupled to one or more data buses 208. Data buses 208 allow for communication among the various devices. Data buses 208 can include wired, or wireless, communication channels.

Processors 201 can include one or more distinct processors, each having one or more processing cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of the extended search computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as machine learning algorithm training data.

Display 206 can display user interface 205. User interfaces 205 can enable user interaction with extended search computing device 102. In some examples, a user can interact with user interface 205 by engaging input-output devices 203. In some examples, display 206 can be a touchscreen, where user interface 205 is displayed by the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 extended search computing device 102 will be operating in. Processor(s) 201 is operable to receive data from, or send data to, a network, such as communication network 118 of FIG. 1, via transceiver 204.

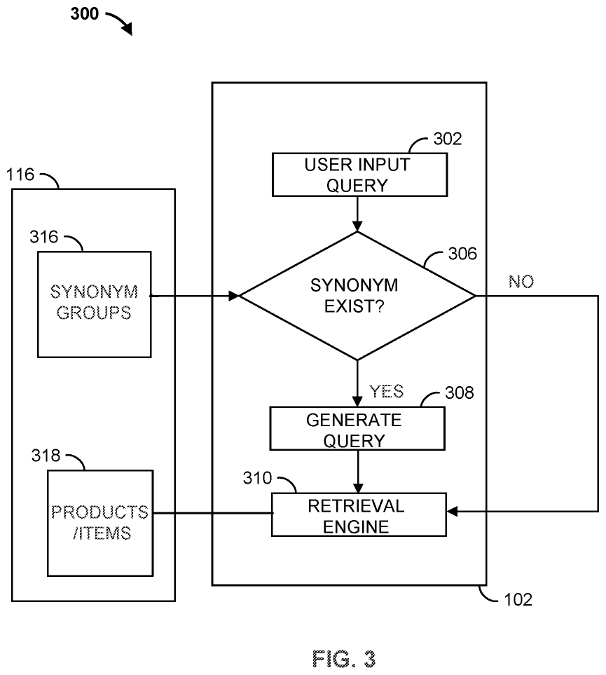

FIG. 3 illustrates at a high level an automated assistant system 300 with an extended search computing device 102 and a database 116 having synonym groups 316 and a product/item catalog 318. A user input query 302 is received and a determination 306 is made as to whether the subject (e.g., product type) of the input query 302 has a synonym group associated with it. The determination may be made by checking an index of the synonym group for the product type. If there are no associated synonym groups, the search is undertaken using the detected product type. Upon a determination that the product type has an association with a synonym group, the associated synonym group 316 is accessed and an extended query is generated with the product type and the product types that are within the synonym group as shown in Block 308. The product/item catalog 318 is searched with the expanded query via the retrieval engine 310 and returned to the user.

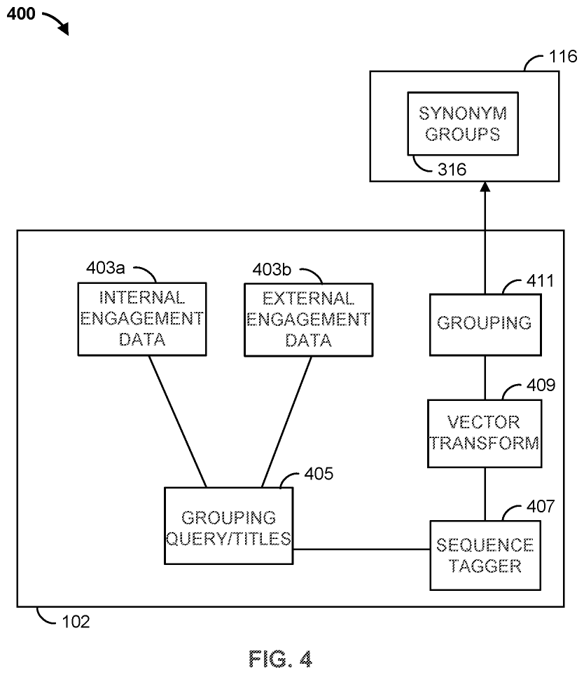

FIG. 4 illustrates an exemplary process 400 for the creation of synonym groups undertaken by the computing device 102 for use in the extended search as described in FIG. 3. Internal engagement data 403a and external engagement data 403b where access is authorized, are grouped/filtered based upon the nature and quantity of engagements as shown in Block 405, specifically the queries, product types, items and/or titles. The internal engagement data may be recent search logs of the retailer, and the external engagement data may be search logs from other retailers upon which access has been granted, or may be from other search engines in which the same processes described herein may be used to determine synonyms, even if the searches are not specifically related to online retail activity (e.g., Google® search logs). The query phrases and/or item titles are sequence tagged 407 using natural language processes and uses graph embedding the tagged phrases/titles are transformed into vector representations 409. Graph embedding, a technique well known in the art, is performed, which results query/results being represented in vector form, examples of graph embedding as known in the art include Deep walk, Random walk, Word2vec, skip-gram, among others. The query phrases/titles are each grouped based on similarity of their vectors as shown in Block 411. The vector similarity may be based on distance D, K closest neighbors, or cosine similarity.

The engagement data 403a and 403b contains the queries previously used to search for products/items/services etc. The queries and results (e.g., product types/ items) are accessed and pairs are collected. Each pair represents a query linked to an items via an engagement. Engagements may be search returns, views, clicks, add-to-cart, or purchases, etc. For example as a result of a query of “Charcoal grills”, the user clicks on one of the “Costway outdoor BBQ”, or adds the product to the cart for purchase, the query and result would be paired via the engagement. The stronger the engagements used (purchases>add-to-cart>click>view>search result) the more confidence may be attributed to the synonym groups, similarly the smaller the distance threshold to determining synonyms will result in higher confidence, as will a higher cosine similarity. Conversely the higher confidence may reduce the number of synonym groups identified. For example Table 1 represents a lower threshold of 0.95 and Table 2 represents a higher threshold of 0.98:

TABLE 1
Cosine threshold = 0.95

| Phrase | Synonyms | | | | | | |
|---|---|---|---|---|---|---|---|
| all | copy | ink | ink | fax | Printer/ | printers | printer |
| in one | machine | refill | cartridges | machine | scanner | | ink |
| printer | | | | | | | |

TABLE 2
Cosine Threshold = 0.98

| Phrase | Synonyms | |
|---|---|---|
| copy machine | Printer/Scanner | |
| Ink refill | Printer ink | Ink cartridges |

Table 2 represents higher quality/confidence synonyms, however at the expense of fewer synonyms mined in Table 1. Thresholds for similarity should be properly set in order to filter out noise, without overly restricting candidate synonyms, thus a compromise between accuracy and coverage must be made.

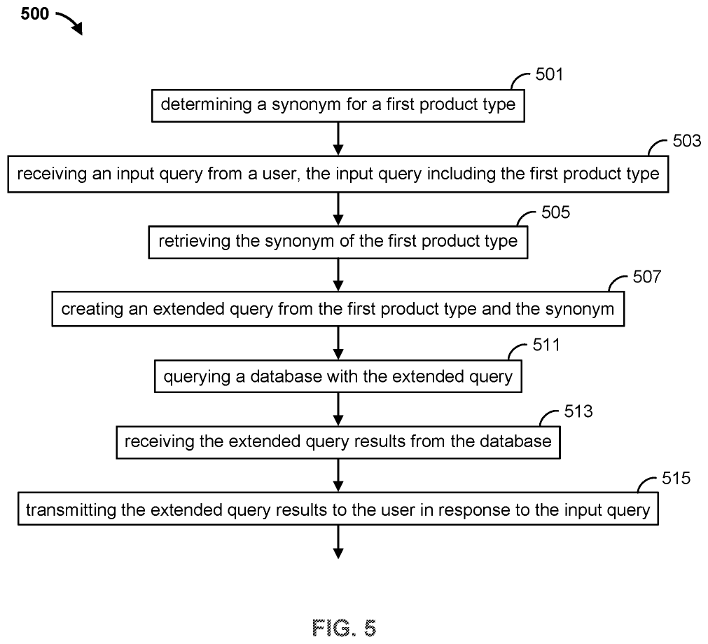

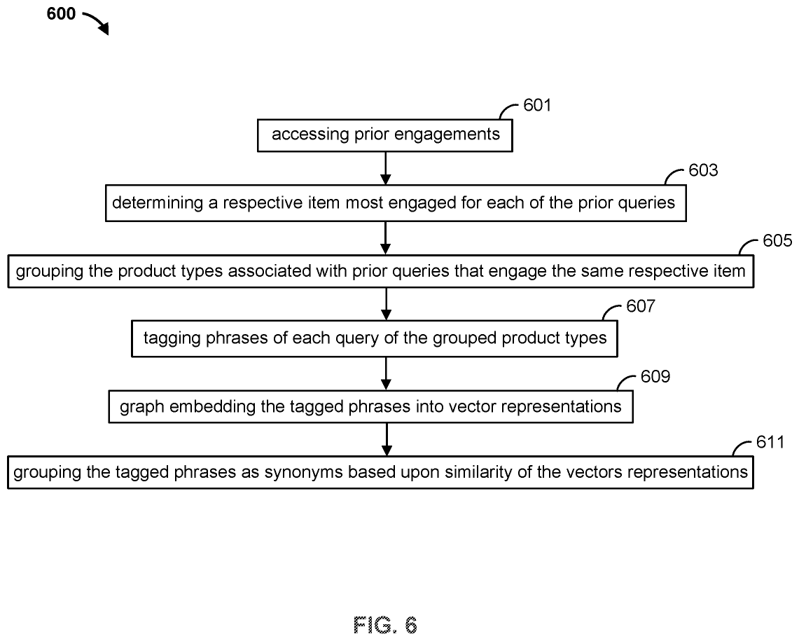

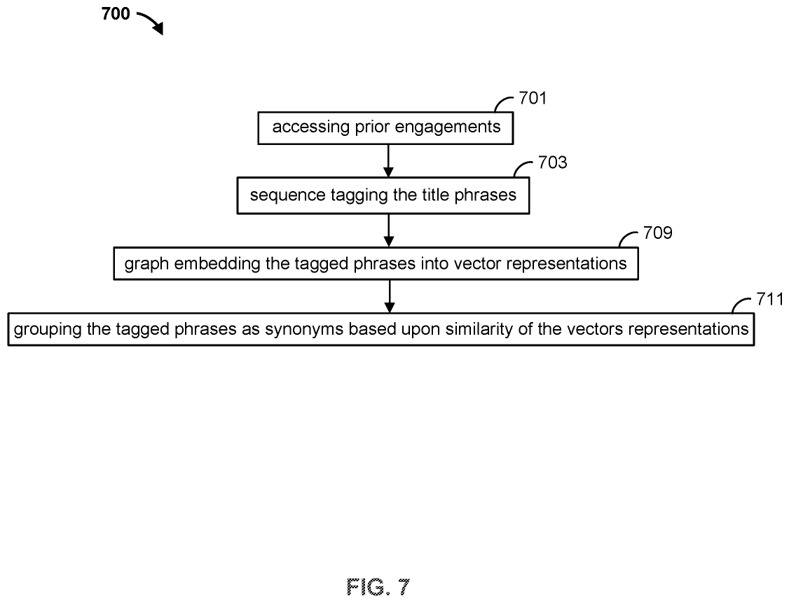

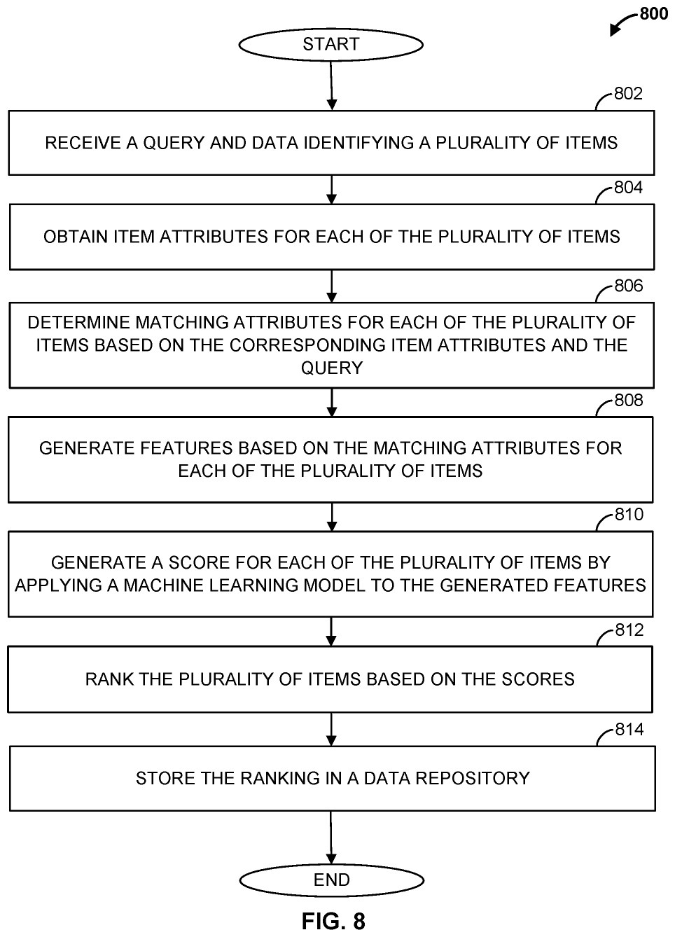

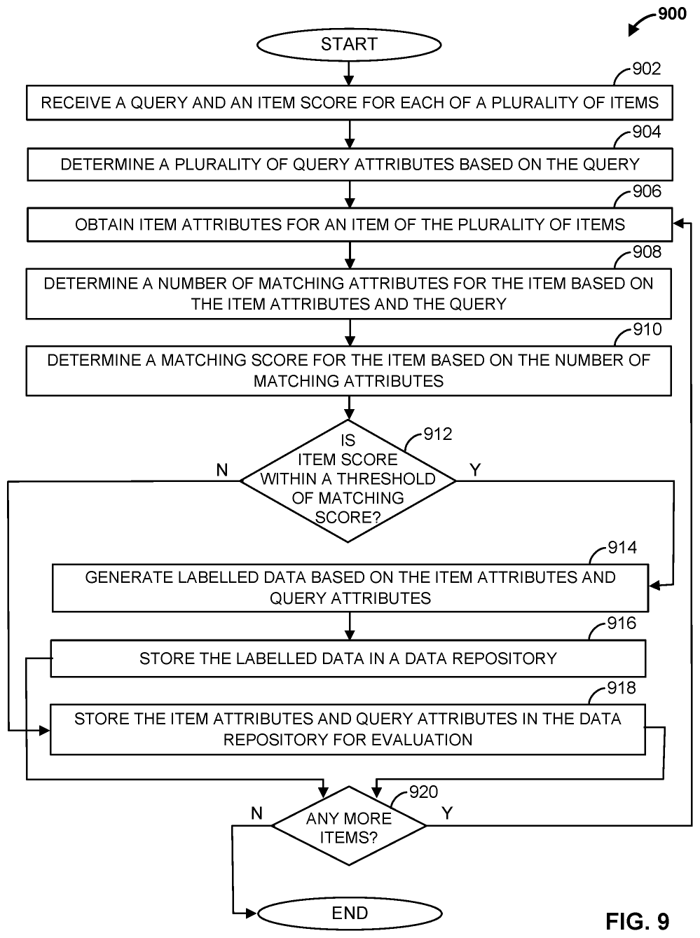

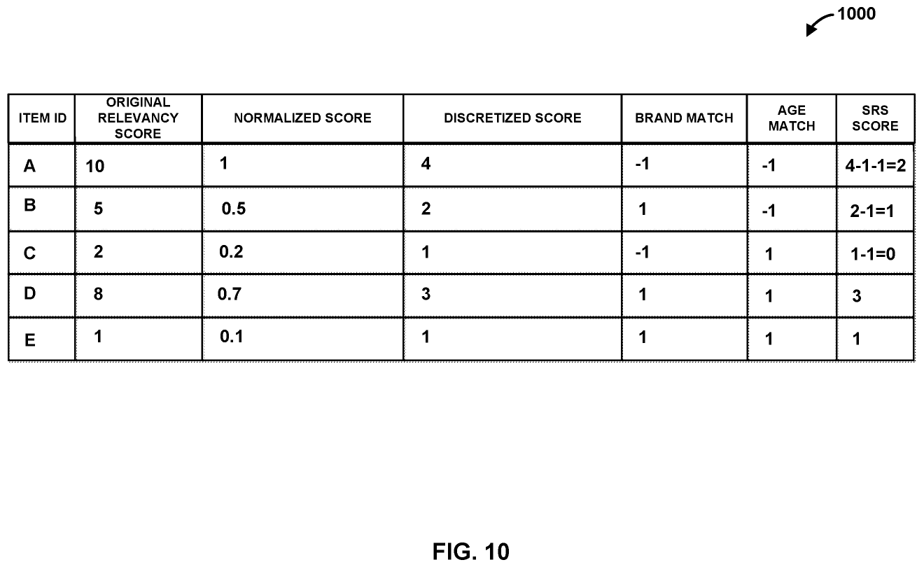

Turning to FIG. 5, is a method 500 for search retrieval which incorporates searching synonyms such that a more complete set of relevant items matching the search intent are retrieved. The method as shown in Block 501 includes determining a synonym for a first product type for example “Dishes” has synonyms of “Dinnerware”, “Dishware” and “Dinner plate.” The synonyms may be determined from prior engagements between prior queries and prior items as discussed further in FIGS. 6 and 7.

Upon receiving an input query as shown in Block 503 (e.g., Show me sunflower dishes?), the extended search computing device 102 with a natural language processor retrieves the synonym of the query subject, for example “Dinnerware” as shown in Block 505. The query subject (e.g., dishes) and a synonym (e.g., dinnerware) are used to create an extended query in Block 507, for example “SEARCH for [sunflower in (dishes or dinnerware)].” Other synonyms, such as “dinner plates” may also be included in the extended query “SEARCH for [sunflower in (dishes or dinnerware or dinner plate)].” The product catalog (database) is searched/queried with the extended query shown in Block 511, the query results are received in Block 513 and transmitted to the user in response to the user's input query as shown in Block 515.

One method 600 to mine synonyms and define synonym groups is shown in FIG. 6. Prior engagements including the prior queries and prior resultant items (i.e. items linked to the queries) are accessed in Block 601. For each of the prior queries, the most engaged item is determined as shown in Block 603. For example the engagements of the prior queries “organic food coloring” and “Natural food dye” are shown in Table 3.

TABLE 3
Engagements

| “Organic Food | No of | | No of |
|---|---|---|---|
| coloring” | Engagements | “Natural Food dye” | engagements |
| Blue Ribbon | 15 | Blue Ribbon | 10 |
| Assorted | | Assorted | |
| Food Color | | Food Color | |
| Blue Ribbon | 12 | Tim’s Food | 8 |
| Natures | | dye Kit | |
| Inspiration | | | |
| food colors | | | |
| Tim’s Food | 2 | Wilton Neon | 2 |
| dye Kit | | gel food colors | |

Blue Ribbon Assorted Food Color for each of the example queries is the most engaged item and thus the two queries may be grouped together. The phrases of each of the group queries are tagged with a sequence tagger in Block 607. For example “Organic” and “Natural” may be tagged as an attribute and “Food coloring” and “Food dye” tagged as product type. The product types and/or the attributes of the groups queries may in themselves be used as synonym groups making “Food coloring” and “Food dye” synonyms as well as “Organic” and “Natural” being another synonym group. To achieve higher confidence synonym graph embedding methods are undertaken to convert the tagged query phrases into a plurality of vector representations as shown in Block 609. The phrases are grouped together into a plurality of synonym groups based upon the respective distance between the phrases, closest neighbors, or cosine similarity as shown in Block 611. For example a threshold distance may be established and each phrase node within the threshold distance D to each other, the K number of closest neighbors, or cosine similarity above a second threshold may each be assigned the same synonym group. In the example above, the vector representation of “Food dye” and “Food coloring” would be similar according to one of more of the above metrics as would the vector representations of “Natural” and “Organic” would likewise be similar. Each member of a synonym group is associated with all the members of the group. This grouping of synonyms is preferably done prior to conducting the extended search and may be conducted on the same or different hardware, additionally, the groupings may be rerun and updated at predetermined time periods or upon the occurrence of pre identified events. These synonym groups are stored in a database 316 and preferably indexed to each group member to aid retrieval of the appropriate synonym group.

In other embodiments, the queries and items may be pre-filtered such that only those engagement pairs in which the number of engagements exceeds a predetermined threshold, for example more than 10 are collected. From Table 3, only the prior query and item pairs: “Organic Food Coloring- Blue Ribbon Assorted Food Color;” “Organic Food Coloring- Blue Ribbon Natures Inspiration food colors;” and “Natural Food dye- Blue Ribbon Assorted Food Color” would be used to determine synonym groups in these embodiments. Thresholds for engagement should not be too strict, to avoid filtering out good candidate queries.

FIG. 7 is another method 700 in which the prior engagement data may be mined for synonyms using the query and item titles (phrases) rather than or in conjunction with the query to query approach as described in FIG. 6. The prior engagements including the item titles are retrieved as shown in Block 701. As noted above, the engagements may be filtered by engagement quantity and/or type. The title phrases of the items are tagged using a sequence tagger of a natural language process as shown in Block 709, for example “Blue Ribbon” may be tagged as a brand, “Assorted” as an attribute (i.e. product description) and “Food Color” as a product type. Using graph embedding or other vector transformation method, the title phrases may be transformed into vector representations as shown in Block 709. The phrases are grouped together into a plurality of synonym groups based upon the respective distance between the phrases, closest neighbors, or cosine similarity as shown in Block 711. In the example above, the vector representation of “Food dye” and “Food color” would be similar according to one of more of the above metrics. These synonym groups are stored in a database 316 and preferably indexed to each group member for group retrieval.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system for extending the retrieval of relevant information comprising:
a communication system;
a database; and,
a computing device operably connected to the database and the communication system, the computing device configured to:
receive a user input query, the user input query including the first product type;
retrieve a synonym of the first product type from a synonym group stored in the database;
create an extended query from the first product type and the synonym;
query the database with the extended query;
receive the extended query results from the database; and,
transmit the extended query results to a user in response to the user input query.

2. The system of claim 1, wherein the computing system is further configured to:
access prior engagements including the product type of prior queries and prior items resultant from the prior queries;
determine a respective item most engaged for each of the prior queries; and,
group the product types associated with prior queries that engage the same respective item.

3. The system of claim 2, wherein the computing system is further configured to:
sequence tag phrases of each query of the grouped product types, and associating commonly tagged phases as groups of synonyms.

4. The system of claim 2, wherein the computing system is further configured to: sequence tag phrases of each query of the grouped products types and graph embedding the tagged phrases into vector representations; and,
group the tagged phrases as synonyms based upon similarity of the vector representations.

5. The system of claim 4, wherein similarity of the vector representations are a function of the cosine similarity of the respective vector representations.

6. The system of claim 1 wherein the computing device is further configured to:
access prior engagements including prior queries and prior items resultant from the prior queries; wherein the prior item include tile phrases;
sequence tag the title phrases;
transform the tagged phrases into vector representations; and,
group the tagged phrases as synonyms based upon similarity of the vectors representations.

7. The system of claim 6, wherein similarity of the vector representations is a function of the cosine similarity of the respective vector representations.

8. The system of claim 1, wherein the computing device comprises an online shopping assistant.

9. A method for improving search retrieval, comprising:
determining a synonym for a first product type;
receiving an input query from a user, the input query including the first product type;
retrieving the synonym of the first product type;
creating an extended query from the first product type and the synonym;
querying a database with the extended query;
receiving the extended query results from the database; and,
transmitting the extended query results to the user in response to the input query.

10. The method of claim 9, wherein the step of determining the synonym comprises:
mining prior traffic data for synonyms and grouping the synonyms.

11. The method of claim 10, wherein the mining prior traffic data comprises:
accessing prior engagements including the product type of prior queries and prior items resultant from the prior queries.

12. The method of claim 11, further comprising:
filtering the prior queries and prior items for associated engagements greater than a predetermined threshold.

13. The method of claim 11, further comprising:
determining a respective item most engaged for each of the prior queries; and,
grouping the product types associated with prior queries that engage the same respective item.

14. The method of claim 13, further comprising tagging phrases of each query of the grouped product types, and associating commonly tagged phases as groups of synonyms.

15. The method of claim 13, further comprising sequence tagging phrases of each query of the grouped products types; graph embedding the tagged phrases into vector representations; and, grouping the tagged phrases as synonyms based upon similarity of the vectors representations.

16. The method of claim 15, wherein the step of grouping the tagged phrases as synonyms includes determining the cosine similarity of the respective vector representations.

17. The method of claim 10, wherein the mining prior traffic data comprises:
accessing prior engagements including prior queries and prior items resultant from the prior queries; wherein the prior items include title phrases,
sequence tagging the title phrases;
graph embedding the tagged phrases into vector representations; and,
grouping the tagged phrases as synonyms based upon similarity of the vectors representations.

18. The method of claim 17, wherein the step of grouping the tagged phrases as synonyms includes determining the cosine similarity of the respective vector representations.

19. The method of claim 11, wherein the prior engagements are selected from the group consisting of search results, views, clicks, add- to-cart and purchases.

20. A non-transitory computer readable medium having instructions stored thereon, wherein the instructions, when executed by at least one processor, cause a device to perform operations comprising:
in a first module;
determining synonyms for a plurality of product types;
storing the determined synonyms in synonym groups;
in a second module:
receiving an input query from a user, the input query including a first product type;
retrieving a respective synonym of the first product type from the synonym group;
creating an extended query from the first product type and the respective synonym;
querying a database with the extended query;
receiving the extended query results from the database; and,
transmitting the extended query results to the user in response to the input query.
